(19) United States
(12) Patent Application Publication
(10) Pub. No.: US 2025/0237210 A1
(43) Pub. Date: Jul. 24, 2025

(54) METHOD FOR PRODUCING HEAT AND COLD IN A FLEXIBLE AND ELASTIC MATERIAL AND ALTERNATIVE DEVICES FOR IMPLEMENTING THIS METHOD

(71) Applicant: Bruno AUBERT, Banyuls-sur-mer (FR)

(72) Inventor: Bruno AUBERT, Banyuls-sur-mer (FR)

(21) Appl. No.: 18/855,554

(22) PCT Filed: Apr. 5, 2022
(86) PCT No.: PCT/EP2023/058974

§ 371 Date: Oct. 9, 2024

(30) Foreign Application Priority Data
Apr. 9, 2022 (FR) 2203272

(51) Int. Cl. F04B 43/02; A43B 7/00; A43B 13/20; B60C 23/18; F25B 9/14

(52) U.S. Cl. CPC F04B 43/02; A43B 7/005; A43B 13/206; B60C 23/18; F25B 9/14

(57) ABSTRACT

The method as the subject of the present invention relates to a method of generating heat and freshness in a flexible material, wherein the flexible material comprises a sealed unit filled with gas, and when pressure is applied to the flexible material, such as when the feet of a person or animal are pressed on the ground, or when a tire comes into contact with a road, the gas trapped in its unit is compressed and expanded.

Flexible materials are preferably made of silicone or other elastic or hyperelastic elastomers, and consist of three layers:
A layer with a so-called cold battery, whose geometric shape or hardness allows for compression before the so-called hot battery,
The layer with a so-called hot battery has a geometric shape or hardness that prevents it from being compressed during the compression period of a so-called cold battery,
The middle layer between the first two layers, including nozzles with geometric shapes suitable for good gas expansion.

These three layers are stacked and assembled in a sealed manner, so that each so-called cold unit is connected to the so-called hot unit through one of the nozzles.

This method can be implemented in shoe soles to maintain a cool temperature when running on burning ground or keeping warm on frozen ground, as these shoe soles are therefore reversible.

At each step, the foot will compress the so-called cold chamber, and all gases will be compressed into the so-called hot chamber through the nozzle. Compressed gas will naturally heat up according to the laws of thermodynamics. When the foot leaves the ground and there is no longer compression, the flexible material will recover its volume through the elasticity of the material, and the so-called cold bubble will suck in gas from the so-called hot bubble, thereby relaxing the gas through the nozzle, which will naturally cool the gas according to the same law. As long as a person walks or runs, the cycle will continue.

The present invention relates to a method for generating heat and cold in a flexible material containing gas-filled, sealed cells by compressing and expanding the gas trapped in the cells, and its associated device.

The preferred application is the sole of the shoe, which can keep the feet a temperature cool even when walking on very hot roads or a temperature warm on the frozen ground.

### PRIOR ART

If there are devices used to heat feet, such as shoe soles or socks, whose resistance is powered by honeycombs or exothermic chemicals, these systems do not allow sufficient heat supply to be maintained for a long enough time for many activities, such as workers in the cold storage, extreme trailers, the military, etc., for 8 hours or longer.

On the other hand, there are few devices available for refreshing shoe soles. There are indeed shoe sole devices filled with gel. These devices are placed in the refrigerator in advance to store the cold energy, but this device is not practical, because on the one hand, the cold energy is very strong at first, which may cause burns, and then quickly becomes less effective. On the other hand, the time to keep the cold energy is very short (several minutes to dozens of minutes). Therefore, it is not suitable for working days or jogging for one hour or longer.

In patent applications KR20160066190, US2012018418, or WO2005087031, there are indeed devices that require the use of Peltier effect components. However, these devices require significant power as the efficiency of the Peltier effect components is not very good. Therefore, due to the rapid depletion of the honeycomb, it is impossible to provide cooling for more than an hour. In addition, these Peltier effect components are typically made of ceramics, and hence are very fragile. Finally, between the weight of the components and the honeycomb, this quickly becomes too heavy in sports shoes which usually are better for lighter.

There are also devices that use breathable materials to discharge water, as described in patent US2018220739, or for better ventilation as described in patent CN107788617, but these systems do not allow for true thermal regulation and significant temperature reduction or increase.

As described in application FR2958505A1, there is also a process of ventilating materials (in this case of shoes) from external air, but this is definitely not a cooling or heating process: it is simply a process of ventilating materials from external air. Therefore, if the outdoor air is very hot, such as in the summer of India (51° C.), the air at 51° C. will enter the shoes! We are still far from temperature regulation. In fact, application FR2958505A1 describes and requests protection for a shoe that, of course, has a bag (large cell), but the bag is connected to the outside and inside of the shoe, so it is absolutely not waterproof (in addition, it is also required to be connected to the outside). This is also confirmed by the fact that in this application, it has never been described or claimed that air is pressurized to realize principles of thermodynamic and especially heating air under pressurization.

In the application FR1501793A, it is also impossible to compress and decompress the air in the cell. On the contrary, it describes and requires a shoe sole with ventilation devices, as mentioned multiple times, the alveoli are open and due to the weight of the person, air pressure cannot be maintained. In addition, it is stipulated that these cells contain powder to be dispersed on the feet, so non sealing characteristics are fundamental.

Therefore, in the applications FR2958505A1 and FR1501793A, it is impossible to heat or cool independently of external air, as they describe the process of ventilating materials from external air. Therefore, if the external air is very hot, such as currently in India (51° C.), then air at 51° C. will enter the shoes! It's impossible to cool your feet with such hot air. Similarly, if the outdoor air is very cold, such as in winter (−30° C., in Canadian mountains . . . ), then air at −30° C. will enter the shoes! It's impossible to heat the feet with such cold air.

Only processes that use thermodynamic principles, such as the one we are reselling in this application, can truly generate heat and cold, and provide true freshness for long periods of time in hot or cold weather (as long as you walk or run).

The application FR 1871095 does mention a thermodynamic method, but its practical application is difficult because the cell is hollow in the material, making compression difficult, and many other innovations must be made, as will be described, to make it more effective. This present application therefore involves: an improved patent depending on application FR 1871095.

### DESCRIPTION OF THE INVENTION

The method as the subject of the present invention relates to a method for generating heat and freshness in a flexible material, wherein the flexible material comprises a sealed honeycomb filled with gas, and when mechanical pressure is applied to the flexible material, such as when human or animal feet presses on the ground, the gas captured in its honeycomb is compressed and expanded.

Flexible materials are preferably made of silicone or other elastic or hyperelastic elastomers such as natural rubber, butyl rubber, . . . and it consists of three layers:
A layer with a so-called cold honeycomb, whose geometric shape or hardness allows for greater mechanical compression than a so-called hot honeycomb,
A layer with so-called hot honeycomb whose geometric shape or hardness is such that it is not compressed or only slightly compressed during mechanical compression of so-called cold honeycomb,

The middle layer between the above-mentioned two layers, including nozzles with geometric shapes suitable for good gas expansion.

The three layers are assembled in a sealed manner, so that each so-called cold honeycomb is connected to the so-called hot honeycomb through one of the nozzles, and all honeycomb honeycombs are filled with surrounding gas during the assembly process.

Therefore, the mechanical compression of flexible materials causes gas to be compressed and thus heated from the honeycombs of the cold layer to the honeycombs of the hot layer through nozzles.

During mechanical decompression, due to the elasticity of the material, the same gas expands and is cooled through the nozzle towards the honeycombs of the cold layer.

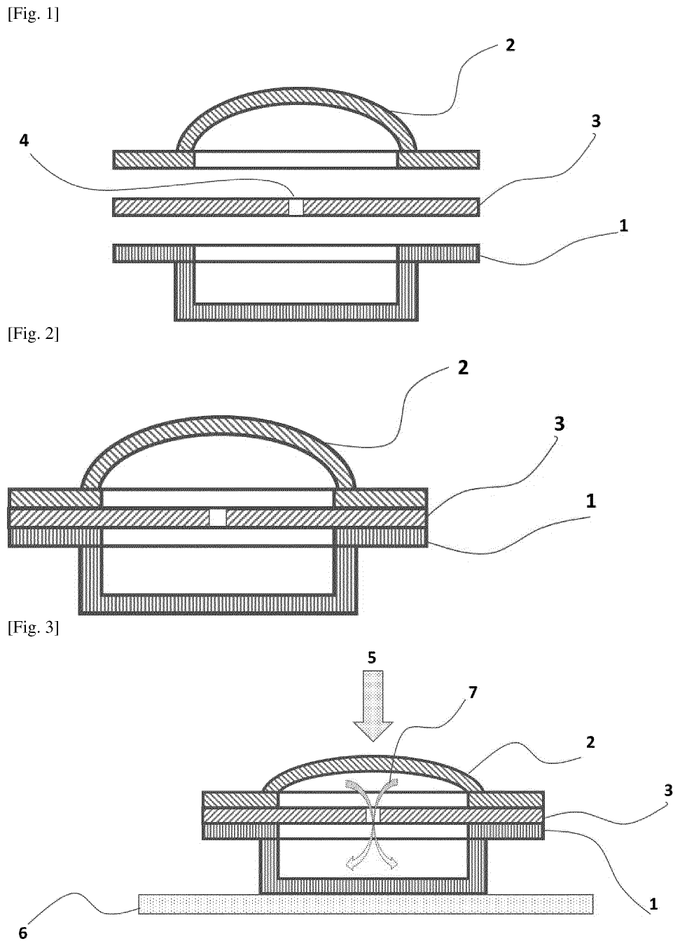

In order to optimize the gas expansion stage during mechanical depressurization, the nozzles can have convergent or divergent shapes, circular, elliptical, or such as Laval nozzles.

[FIG. 1] shows the honeycomb before assembly of a hot layer (1), a compressed air receiving area, a cold layer (2), a compressed air expansion area, and an intermediate layer (3) containing nozzles (4).

These three layers overlap, allowing each so-called cold honeycomb to be connected to the so-called hot honeycomb through one of the nozzles, as shown in FIG. 2.

These three layers can be assembled into an airtight structure under atmospheric pressure or pressure, allowing the honeycomb to be filled with gas under pressure or not.

Sealing is a very important feature. In fact, if we use a material having permeability to gases (such as air) exceeding 20 bar, compression/expansion cycles will result in slow but gradual air leakage, leading to permanent honeycombs rupture and hence limiting thermodynamic operations. The generation of heating and cooling is only effective within 1 to 2 hours. For example, to ensure 8 hours of thermodynamic production (one working day), a permeability of less than 4 bar is sufficient, and for operations greater than 40 hours (e.g. for extreme trajectories), a permeability of less than 1 bar is required.

In order to prevent the so-called hot honeycomb from being compressed or slightly compressed during the mechanical compression of the so-called cold honeycomb, this can be achieved through specific geometric shapes, such as preferably adding reinforcing elements inside the honeycomb or increasing the thickness of the honeycomb wall, or achieving higher hardness than the so-called cold honeycomb.

If the hardness of the so-called hot honeycombs allows them to remain uncompressed or only slightly compressed during mechanical compression of so-called cold honeycombs, then this hardness will be at least 10 Shore A greater than the hardness of the latter.

Therefore, flexible materials can be used as the sole of shoes to maintain a cool temperature, such as when a person is running on hot ground. At each step, the foot will compress the so-called cold alveoli, and the gas from these alveoli will be pushed towards the so-called hot alveoli through the nozzle. Therefore, the hot alveoli will act as an insulating shell, and their gas will be heated during compression.

When the foot leaves the ground and there is no longer mechanical compression, the flexible material will recover its volume through the elasticity of the material and inhale gas through the nozzle, thereby relaxing the gas and cooling it.

The hardness value for the so-called cold honeycomb is 10 to 30 Shore A, and the hardness value for the so-called hot honeycomb is 20 to 50 Shore A. Please note that if two layers have the same hardness, the gas compressed by foot pressure will be evenly distributed between the incompletely compressed alveoli of the two layers, and heating will be evenly distributed. Therefore, during the expansion process, thermodynamics tells us that the temperature will return to its initial value, so we cannot obtain hot and cold surfaces.

Therefore, due to the difference in compressibility between the two types of alveoli, whether it is the difference in hardness of the two layers or the difference in shape, the so-called cold alveoli deform through the pressure of the feet, so that all compressed gas enters the so-called hot alveoli, while the hot alveoli actually do not deform. Therefore, compressed gas naturally heats up according to the laws of thermodynamics and exists completely in the so-called thermal honeycomb, the so-called thermal honeycomb therefore is at higher temperatures than the so-called cold honeycombs.

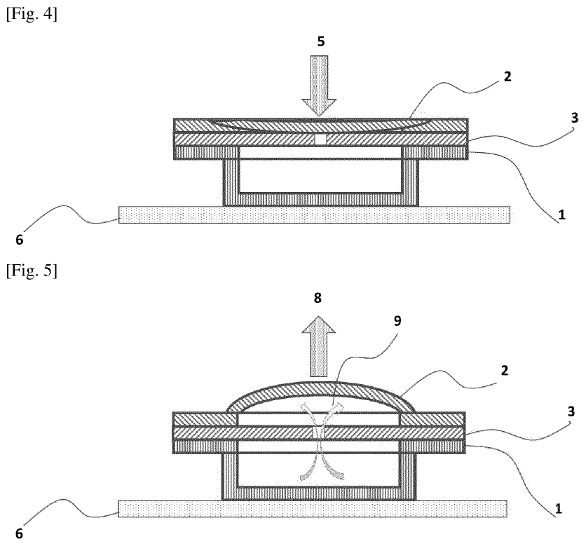

Elastic materials, such as silicone resin, do not have significant electrical conductivity. Therefore, alveoli may not be able to transfer enough heat or cold to the feet, and they will act as an insulating shell without exchanging with the outside. Therefore, it is preferred to increase the thermal conductivity in the hot and cold layers by adding powdered metal (such as copper) or diamond powder to the elastomer, but not in the middle part containing the nozzle, to ensure thermal insulation and sufficient separation of heat flow.

[FIGS. 2] to [5] show the device in cross-section, which is intended to be arranged, for example, as a sole in shoes with so-called cold holes in contact with the foot. Example of air operation:

[FIG. 2], the flexible honeycomb material is in a stationary state, and gas is uniformly distributed in the honeycomb at temperature Ta and pressure Pa. Two types of honeycomb and nozzle are distinguished.

[FIG. 3], pressure, such as the foot pressure shown by arrow (5) on the floor (6), is applied to the flexible material, and due to the fact that the so-called cold honeycomb is more compressible than the so-called hot honeycomb, all air (7) enters the latter.

[FIG. 4], then the gas will be compressed to a pressure Pi (depending on the applied pressure, i.e. about 2 bar for an equal volume honeycomb), and thus heated to a temperature Ti according to thermodynamic laws. Therefore, the temperature Ti of the gas will be equal to:

$$Ta * {( Pi / Pa )}^{( γ - 1 ) / γ} \qquad [ Mathematics ]$$

Among them, γ is the adiabatic constant of the gas (1.4 for air at 293° K), and if Ta is 293° K, it is 376° K. Then, the heat of the gas will dissipate in the material to the feet or floor (or shoes).

FIG. 5 shows the material during pressure release (when the foot is off the ground). The elasticity of the material restores the shape of the alveoli, and the force is represented by arrow (8). The pressurized gas at temperature Tf will leave the so-called hot honeycomb in order to expand through the nozzle in the so-called cold honeycomb, thereby cooling to reach temperature Tc:

$$Tf \times {( Pa / Pi )}^{( γ - 1 ) / γ} \qquad [ Math 2 ]$$

That is, 285° K, which is 8° K lower than the initial temperature Ta.

This is actually a thermodynamic process that generates cold and heat in the sole of the shoe, which claims to be similar to what happens in air conditioners using Carnot cycles (compression/expansion) in the so-called hot chamber (compression zone), so-called cold chamber (expansion zone), and compressor (foot). The innovative feature is that the loop is made of a flexible material that can be compressed and return to its initial shape due to its elasticity.

According to another arrangement, flexible materials can be used as heating devices. To do this, simply flip the sole of the shoe so that the so-called hot alveoli come into contact with the foot. Therefore, the heat generated during the compression process will come into contact with the foot, while the cold layer will come into contact with the bottom of the shoe.

The flexibility, elasticity, or superelasticity (and therefore highly deformable) properties of materials are crucial for human weight to cause deformation of the flexible material and for the material to quickly recover its initial shape after releasing pressure.

Therefore, the size of the alveoli can be determined based on the weight of the person and the size of the shoes, so that the pressure is sufficient to compress the so-called cold alveoli appropriately.

Preferably, the alveoli must be embossed to minimize the surrounding material (hollow alveoli in the material are more difficult to compress with feet).

The volume ratio of cold and hot honeycombs is also important. In fact, if they have the same volume, during the complete mechanical compression process in the cold chamber, all gases in the hot chamber will be at a pressure of 2 bar, which corresponds to an increase in air temperature of about 83° C.

On the other hand, if the volume of the so-called cold chamber is twice that of the hot chamber, the pressure obtained during the compression process will be 3 bar, and the air temperature will rise by about 120° C., which will allow for better heating of the feet.

The gas contained in the cells may simply be air, but it is advantageous to use gases with a higher adiabatic constant γ, such as monoatomic gases (for example, argon) or polyatomic gases (for example, CO₂), and possibly with a humidity greater than 20% (to utilize the latent heat of vaporization of water) in order to achieve higher efficiency.

According to another preferred arrangement, the material and the shape of the cells can be adapted to the morphology of domestic animals such as cats and dogs, which often burn their paw pads when walking on sunny roads, especially rescue dogs.

According to another arrangement, this porous flexible material can be used as a carpet in public places or enterprises with frequent human traffic so that the numerous pressures of feet can achieve temperature regulation.

According to another arrangement, this porous flexible material can be used in tires to achieve continuous cooling. This is even more meaningful because electric vehicles, which are about to replace internal-combustion-engine vehicles, are heavier and have more torque, and thus their tires are more prone to heating.

In this case, it is advantageous to group the cells of the “hot” layer to form the actual tire chamber, and the cells of the “cold” layer will be arranged on the periphery of the tire, where they will undergo compression and expansion cycles when the vehicle is running. However, in this case, it is preferable that the cells are hollow because the pressure exerted by the vehicle is much greater than that exerted by a foot.

According to another arrangement, this porous flexible material can be used in peristaltic pumps. It is only necessary to arrange the cells around the elastic material pipe responsible for transportation, and the pumped fluid can be cooled or heated.

1. A flexible and elastic material comprising a layer provided with so-called cold compressible cells (2) and a layer provided with so-called hot cells that are less compressible than the previous ones (1), the so-called cold cells having a geometry or hardness allowing for greater compression than the so-called hot cells, which have a geometry or hardness that allows them to be not or little compressed when the so-called cold cell is compressed, wherein:
the flexible and elastic material comprises an intermediate layer disposed between the two previous layers and including nozzles (1) with a geometry adapted for good gas expansion,
said cells are in relief to allow easier mechanical compression and return to the initial shape, and
the three layers are assembled in a sealed manner so that each so-called cold cell (2) is in communication with a so-called hot cell (1) via one of said nozzles and that all the cells are filled with the surrounding gas during assembly.

2. The flexible and elastic material according to claim 1, comprising a hot layer (1) and a cold layer (2) having an increased thermal conductivity by adding powder with high thermal conductivity to said material and an intermediate layer (3) provided with nozzles having low thermal conductivity.

3. The flexible and elastic material according to claim 1, wherein said material has cells (1) and (2) that are airtight and contain air, CO2 or argon.

4. The flexible and elastic material according to claim 1, wherein said material has cells (1) and (2) that are airtight and contain moist air, CO2 or argon.

5. The flexible and elastic material according to claim 1, wherein the flexible and elastic material forms part of a shoe sole.

6. The flexible and elastic material according to claim 1, wherein the flexible and elastic material forms part of a floor mat.

7. The flexible and elastic material according to claim 1, wherein the flexible and elastic material forms part of a flexible peristaltic pump hose.

8. The flexible and elastic material according to claim 1, wherein the flexible and elastic material forms part of a vehicle tire.

9. The flexible and elastic material according to claim 2, wherein said material has cells (1) and (2) that are airtight and contain air, CO2 or argon.

10. The flexible and elastic material according to claim 2, wherein said material has cells (1) and (2) that are airtight and contain moist air, CO2 or argon.

11. The flexible and elastic material according to claim 3, wherein said material has cells (1) and (2) that are airtight and contain moist air, CO2 or argon.

12. The flexible and elastic material according to claim 2, wherein the flexible and elastic material forms part of a shoe sole.

13. The flexible and elastic material according to claim 3, wherein the flexible and elastic material forms part of a shoe sole.

14. The flexible and elastic material according to claim 4, wherein the flexible and elastic material forms part of a shoe sole.

15. The flexible and elastic material according to claim 2, wherein the flexible and elastic material forms part of a floor mat.

16. The flexible and elastic material according to claim 3, wherein the flexible and elastic material forms part of a floor mat.

17. The flexible and elastic material according to claim 4, wherein the flexible and elastic material forms part of a floor mat.

18. The flexible and elastic material according to claim 2, wherein the flexible and elastic material forms part of a flexible peristaltic pump hose.

19. The flexible and elastic material according to claim 3, wherein the flexible and elastic material forms part of a flexible peristaltic pump hose.

20. The flexible and elastic material according to claim 4, wherein the flexible and elastic material forms part of a flexible peristaltic pump hose.
